(19) United States
(12) Patent Application Publication
(10) Pub. No.: US 2009/0117986 A1
(43) Pub. Date: May 7, 2009

(54) MULTI-LINE AND MULTI-REEL HOLD AND PLAY WITH RESTRUCTURED PAYS SYSTEM

(75) Inventors: Ricco Novero, Henderson, NV (US); Keith Rucker, Las Vegas, NV (US)

Correspondence Address: STEPTOE & JOHNSON, LLP, 2121 AVENUE OF THE STARS, SUITE 2800, LOS ANGELES, CA, 90067, US

(73) Assignee: BALLY GAMING, INC., Las Vegas, NV (US)

(21) Appl. No.: 12/259,935

(22) Filed: Oct. 28, 2008

Related U.S. Application Data
(60) Provisional application No. 60/985,954, filed on Nov. 6, 2007.

(51) Int. Cl. A63F 9/24; A63F 13/00

(52) U.S. Cl. 463/20

(57) ABSTRACT

A reel spinning gaming device comprises a plurality of selectable reels, where a subset of the multiple reels and pay lines are held to create skill play. The prize controller determines whether a prize is to be awarded based upon an outcome symbol combination. Weighted reel strips are employed to adjust payout percentages pursuant to established regulations.

### CROSS-REFERENCE TO RELATED APPLICATIONS

This application claims the benefit of U.S. Provisional Application No. 60/985,954, filed Nov. 6, 2007 and is herein incorporated by reference in its entirety. This application is related to co-pending U.S. patent application Ser. No. ______, filed ______.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This invention relates generally to a reel spinning game, and more particularly, to a reel spinning game wherein multiple line and/or reels can be held for use in a subsequent game.

### BACKGROUND

In a traditional reel-spinning slot machine, each spin of the reels is typically a separate and distinct game, which has no relationship with any prior or future game played on that machine. As such, there is a need for a game that will increase player excitement and maintain player interest between consecutive games. To address this issue, multiple lines and/or reels can be used in one or more subsequent games to provide the player with another opportunity to win or increase winnings.

Some slot machines allow a player to “nudge” one of the reels so that a displayed symbol is replaced by an adjacent symbol on the reel. The success or failure of the game is then recalculated based upon the new symbol combination appearing after the reel has been nudged. While this nudging feature does address the issue of being one symbol short of a winning combination, it provides only limited relief. Additionally, certain games permit a single line or reel to be held. However, there is a continuing need for alternative slot machine variants that provide at least a “second chance” (or more) for a player to achieve a win, after initially achieving a win or a near win in a prior game, thereby maintaining player excitement between individual games.

Therefore, it is desirable to provide a player with options for playing an additional game that maintain some portion of the outcome symbol combination from the previous game. However, such flexibility in gaming must satisfy established payout regulations. Accordingly, those skilled in the art have long recognized the need for a gaming machine that addresses these issues.

### SUMMARY

Briefly, and in general terms, the present disclosure is directed towards a gaming system and method that permits skill play and incorporates an approach to adjust payout percentages. In one application, a reel spinning or related game including indicia-bearing members is provided which permits multiple lines and/or multiple reels to be held for use in a future game. Such a gaming system or method thus involves a skill component. Accordingly, the present disclosure also addresses potentially decreasing payout percentages that can potentially be associated with skill play.

One embodiment of a game of the present disclosure employs virtual weighted reel strips. Such virtual weighted reel strips can be utilized across all bets. In a contemplated approach, more than one line is used where each paying line combination has an equal number of hits on each line.

Other features and advantages will become apparent from the following detailed description, taken in conjunction with the accompanying drawings, which illustrate by way of example, the features of the various embodiments.

### BRIEF DESCRIPTION OF THE DRAWING

FIG. 1 is a perspective view of one embodiment of a gaming device;

FIG. 2 is a diagram of one embodiment of a gaming system including one or more gaming machines;

FIG. 3 is a front view, depicting a reel control display for a system incorporating the present disclosure;

FIG. 4 is a front view, depicting a reel symbol weight chart;

FIG. 5 is a front view, depicting a secondary display of the system of FIG. 3;

FIG. 6 is a front view, depicting a help screen for the system of FIG. 3;

FIG. 7 is a front view, schematically depicting operation of the system of FIG. 3;

FIG. 8 is a front view, schematically depicting another feature of the operation of the system of FIG. 3;

FIG. 9 is a front view, depicting inserting weight symbols into the secondary display of FIG. 5; and

FIG. 10 is a front view, depicting inserting pay inserts into the secondary display of FIG. 5.

### DETAILED DESCRIPTION

The present disclosure is directed towards a gaming system and method which permits skill play in a reel based game through the holding of multiple lines and/or reels. The present disclosure also provides for a method and system to adjust payout percentages to meet gaming regulation criteria. The present disclosure is also applicable to other non-reel games involving similar challenges.

In applications incorporating the present disclosure, it was determined that when X number of credits are bet, it is required that percentage payback of any bet involving greater than X must be greater than or equal to the payback percentage relating to that of bet X. It was also determined that with optimal expected value play strategy, all awards for a game incorporating the present disclosure must be less than 17 million to 1. Thus, the present disclosure contemplates changing pays associated with indicia-bearing members (i.e. symbols) so that for each possible combination, a win value would be greater than or equal to all of the win values at possible lower wages. To arrive at a suitable payout table, all possible holds on all possible window combinations for a cycle are evaluated. Maximum values are summed for each possible window combination to arrive at an overall expected value for each line/credit wagered. Attached hereto as Appendix A are case notes establishing payback percentages within relevant gaming regulations for an approach incorporating the present disclosure.

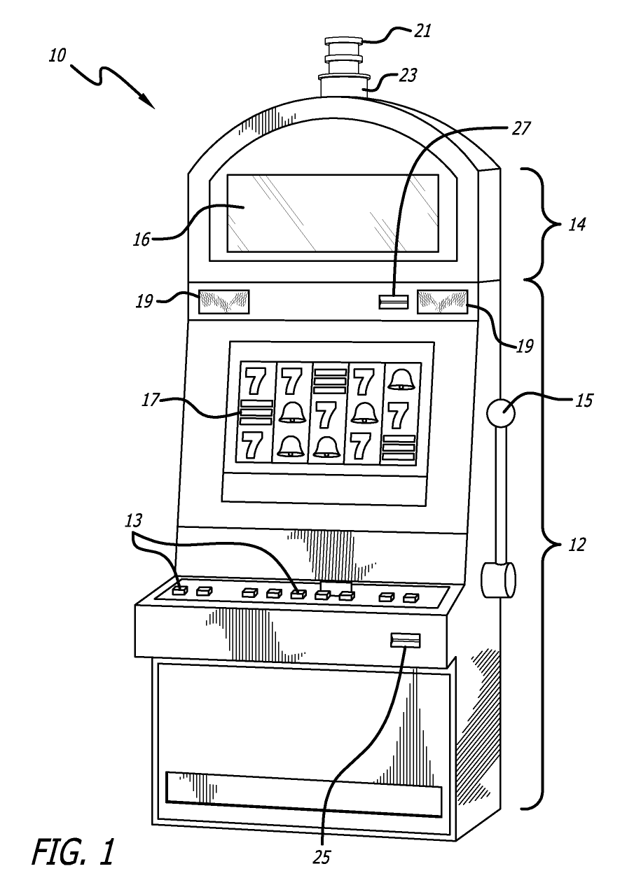

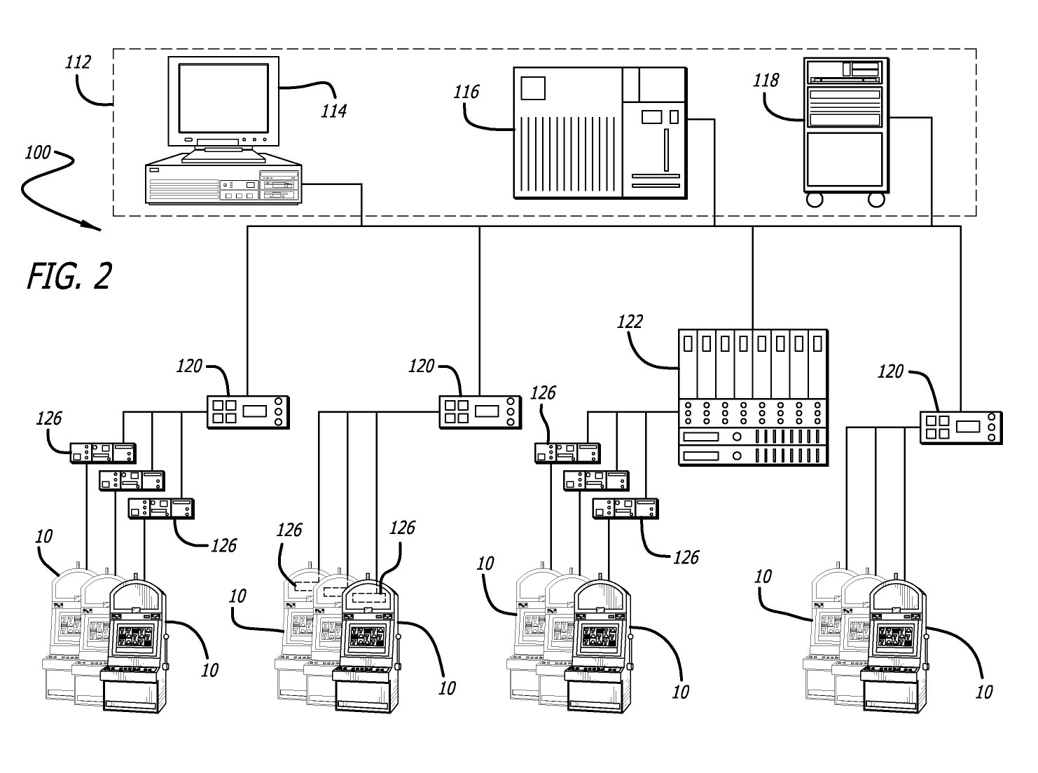

Referring now to the drawings, wherein like reference numerals denote like or corresponding parts throughout the drawings and, more particularly to FIGS. 1 and 2, there are shown various embodiments of a reel based gaming machine. More specifically, as shown in FIG. 1, the gaming machine 10 includes a main cabinet 12 and a top box 14. The gaming machine also includes various player input devices 13, 15 to play one or more games presented on a main display 17.

Referring back to FIG. 1, the main cabinet 12 of the gaming machine 10 is a self-standing unit that is generally rectangular in shape. Alternatively, in other embodiments, the gaming cabinet may be a slant-top gaming cabinet or any shaped cabinet known or developed in the art. Additionally, the cabinet may be manufactured with reinforced steel or other rigid materials that are resistant to tampering and vandalism. Optionally, in an alternate embodiment, the gaming machine 10 may instead be a cinema-style gaming machine (not shown) having a widescreen display.

As shown in FIG. 1, the gaming device 10 includes a main display 17. According to one embodiment, the main display 17 is a plurality of mechanical reels for presenting a slot-style game. Alternatively, the main display 17 is a video display for presenting one or more games such as, but not limited to, mechanical slots, video slots, video keno, video poker, video blackjack, video roulette, Class TI bingo, games of skill, games of chance involving some player skill, or any combination thereof.

According to yet another embodiment, the main display 17 is a widescreen display (e.g., 16:9 or 16:10 aspect ratio display). In one embodiment, the display 17 is a flat panel display including by way of example only, and not by way of limitation, liquid crystal, plasma, electroluminescent, vacuum fluorescent, field emission, LCOS (liquid crystal on silicon), and SXRD (Silicon Xtal Reflective display), or any other type of panel display known or developed in the art. These flat panel displays may use panel technologies to provide digital quality images including by way of example only, and not by way of limitation, EDTV, HDTV, or DLP (Digital Light Processing). The widescreen display 17 may be mounted in the gaming cabinet 12 in a portrait or landscape orientation. In another embodiment, the game display 17 may also include a touch screen or touch glass system (not shown). The touch screen system allows a player to input choices without using any electromechanical buttons 13. Alternatively, the touch screen system may be a supplement to the electromechanical buttons 13.

According to one embodiment, the top box 14 is a separate and distinct component that is affixed to the main cabinet 12. In another embodiment, the top box 14 is an area that is partitioned from the main cabinet 12. Alternatively, the top box 14 and the main cabinet 12 may be contiguous areas with the outward appearance of two distinct components. According to one embodiment, the top box 14 includes a display glass. The display glass may include the name of the game, artwork, game instructions, pay table, or other information relating to the game.

According to another embodiment, the top box 14 includes a secondary display for displaying game information (e.g., name of the game, game marquee, animation, one or more pay tables, game information, one or more help menus, one or more secondary games, progressive jackpot information or tournament game information) or non-game related information (e.g., news, advertisements, messages or promotions). The secondary display 16 may be a flat panel display, dot matrix display, cathode ray tube display, display glass, backlit display glass, diorama, three-dimensional relief, pachinko-style secondary game, one or more wheels, one or more mechanical reels, or a combination thereof. The display 16 may have a wide screen aspect ratio (4:3, 16:9, 16:10 or the like) and the display may or may not include a touch screen or other touch device associated therewith. Optionally, the secondary display is movable (e.g., tilted a few degrees downward or upward) so that the display is more easily viewed by a casino patron. The movement of the display may be done manually or automatically (e.g., motor or linear actuator).

Additionally, as shown in FIG. 1, the top box 14 includes a candle 21 having three tiers. As those skilled in the art will appreciate, other embodiments of the candle 21 may include one or more tiers. The tiers may be jointly or individually illuminated with one or more incandescent light bulbs or light emitting diodes (LEDs). In one embodiment, the bottom tier 23 of the candle 21 includes a plurality of multi-colored LEDs. Additionally, a plurality of LED reflectors (not shown) are provided within the bottom tier 23 of the candle 21. For example, in one embodiment, eight reflectors are provided within the bottom tier in a octagonal configuration (when viewed from above). Accordingly, the LEDs in the bottom tier 23 of the candle 21 may be alternately illuminated (in the same or different colors) around the circumference of the bottom tier to simulate a rotating light. Alternatively, the LEDs may flash in one or more colors. Accordingly, the LEDs in the bottom tier 23 of the candle 21 may be programmed to illuminate when a jackpot is triggered. The lights in the top tiers of the candle 21 may be illuminated to signal that a player needs assistance from a casino floor employee, a jackpot has been won, or that a responsible gaming message has been presented to a player.

As shown in FIG. 1, the gaming device 10 includes a plurality of player-activated buttons 13. These buttons 13 may be used for various functions such as, but not limited to, selecting a wager denomination, selecting a number of games to be played, selecting the wager amount per game, initiating a game, or cashing out money from the gaming machine 10. The buttons 13 function as input mechanisms and may include mechanical buttons, electromechanical buttons or touch screen buttons. In another embodiment, one input mechanism is a universal button module that provides a dynamic button system adaptable for use with various games. Additionally, other input devices, such as but not limited to, touch pad, track ball, mouse, switches, toggle switches, are included with the gaming machine to also accept player input. Optionally, a handle 15 may be “pulled” by a player to initiate a slots-based game.

In an alternate embodiment, a cellular phone or other input device (e.g., PDA), separate and apart, from the gaming machine 10 may also be used to input various player choices and information to enhance the player's interactive experience with the gaming machine. Furthermore, inputting information via these devices provides an added level of security as any key presses may be hidden from view. In yet another embodiment, a player may call or send a text message or a short message service (SMS) to the gaming machine.

As shown in FIG. 1, the gaming device 10 includes a ticket reader/ticket printer slot 25 that is associated with a cashless gaming system (not shown). As shown in FIG. 1, a single slot 25 is used for the ticket reader and ticket printer. Accordingly, the same slot 25 may be used to insert and/or issue a ticket. However, in alternate embodiments, separate slots (not shown) may be provided for the ticket acceptor and the ticket printer. In one embodiment, the ticket reader (not shown) of the cashless gaming system is capable of accepting previously printed vouchers, paper currency, promotional coupons, or the like. The ticket printer (not shown) of the cashless gaming system generates vouchers having printed information that includes, but is not limited to, the value of the voucher (i.e., cash-out amount) and a barcode that identifies the voucher. In yet another embodiment, the ticket printer generates tax receipts for charitable donations made on the responsible gaming machine.

Additionally, the gaming device includes a player tracking system (not shown). The player tracking system allows a casino to monitor the gaming activities of various players. Additionally, the player tracking system is able to store data relating to a player's gaming habits. That is, a player can accrue player points that depend upon the amount and frequency of their wagers. Casinos can use these player points to compensate the loyal patronage of players. For example, casinos may award or “comp” a player free meals, room accommodations, tickets to shows, and invitations to casino events and promotional affairs.

Typically, the player tracking system is operatively connected to one or more input components on the gaming machine 10. These input components include, but are not limited to, a slot 27 for receiving a player tracking card, a keypad or equivalent, an electronic button receptor, a touch screen and the like. The player tracking system may also include a database of all qualified players (i.e., those players who have enrolled in a player rating or point accruing program). Generally, the database for the player tracking system is separate from the gaming devices.

In another embodiment, the gaming device 10 includes an internet connection or other known network connections to link one or more gaming devices together. According to one embodiment, the internet connection is used for web browsing, prize redemption, or access to other gaming or non-gaming information. Additionally, with the various gaming devices in communication with one another (or a system host), the gaming device 10 may participate in a gaming tournament. In one embodiment, the gaming tournament is a competitive gaming tournament having one (or a few) winners. Alternatively, the gaming tournament is a cooperative gaming tournament where all eligible gaming devices win a particular award.

One of ordinary skill in the art will appreciate that not all gaming devices have all these components and that the gaming devices may have other components in addition to, or in lieu of, those components mentioned here. Furthermore, while these components are viewed and described separately, various components may be integrated into a single unit in some embodiments.

Referring now to FIG. 2, a casino gaming system 100 is illustrated. The casino gaming system 100 comprises one or more gaming devices 10. In various embodiments, any of the gaming devices 10 may be any type of electronic or mechanical gaming devices, such as, but not limited to, a mechanical reel spinning slot machine, video slot machine, video poker machine, keno machine, video blackjack machine, or a gaming machine offering one or more of the above-described games. Examples include, but are not limited to, the S6000 mechanical reel spinner and the Alpha video slot machine from Bally Technologies, Inc. The gaming devices 10, illustrated in FIG. 2 act as terminals for interacting with a player playing a casino game. Networking components facilitate communications between the system server 112 and game management units 126 that control displays for carousels of gaming devices 10 across a network 740. Game management units (GMU's) 126 connect gaming devices to networking components and may be installed in the gaming machine cabinet or external to the gaming machine 10. The function of the GMU 126 is similar to the function of a network interface card connected to a desktop personal computer (PC). Some GMU's 126 have much greater capability and can perform such tasks as presenting and playing a game using a display (not shown) operatively connected to the GMU 126. In one embodiment, the GMU 126 is a separate component located outside the gaming machine 10. Alternatively, in another embodiment, the GMU 126 is located within the gaming machine 10. Optionally, in an alternative embodiment, one or more gaming devices 10 connect directly to a network and are not connected to a GMU 126.

Furthermore, one or more of the gaming devices 10 includes one or more data repositories for storing data. Examples of information stored by the gaming devices 10 include, but are not limited to, accounting data, maintenance history information, short and/or long-term play data, real-time play data, and sound data. The sound data may include, but is not limited to, audio files, sound clips, wav files, mp3 files and sound files saved in various other formats. Furthermore, each gaming machine 10 comprises an audio system (not shown) for outputting sound.

The gaming devices 10 are connected via a network to a network bridge 120, which is used for networking, routing and polling gaming devices, including slot machines. The network bridge 120 connects to a back end system 112. Optionally, the gaming devices 10 may connect to the network via a network rack 122, which provides for a few number of connections to the back end system 112. Both network bridge 120 and network rack 122 may be classified as middleware, and facilitate communications between the back end system 112 and the game management units 126. The network bridges 120 and network rack 122 may comprise data repositories for storing network performance data. Such performance data may be based on network traffic and other network related information. Optionally, the network bridge 120 and the network rack 122 may be interchangeable components. For example, in one embodiment, a casino gaming system may comprise only network bridges and no network racks. Alternatively, in another embodiment, a casino gaming system may comprise only network racks and no network bridges. Additionally, in an alternative embodiment, a casino gaming system may comprise any combination of one or more network bridges and one or more network racks.

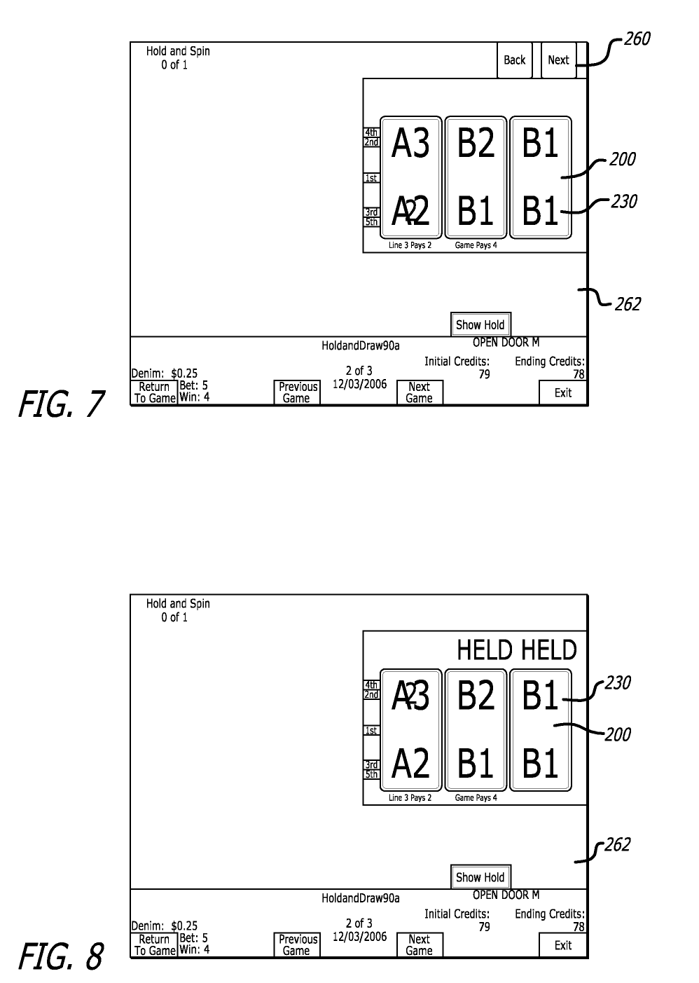

The back end system 112 may be configured to comprise one or more servers. The type of server employed is generally determined by the platform and software requirements of the gaming system. In one embodiment, as illustrated in FIG. 7, the back end system 112 is configured to include three servers: a slot floor controller 114, a casino management server 116 and a casino database 118. The slot floor controller 114 is a part of the player tracking system for gathering accounting, security and player specific information. The casino management server 116 and casino database 118 work together to store and process information specific to both employees and players. Player specific information includes, but is not limited to, passwords, biometric identification, player card identification, and biographic data. Additionally, employee specification information may include biographic data, biometric information, job level and rank, passwords, authorization codes and security clearance levels.

Overall, the back end system 112 performs several fundamental functions. For example, the back end system 112 can collect data from the slot floor as communicated to it from other network components, and maintain the collected data in its database. The back end system 112 may use slot floor data to generate a report used in casino operation functions. Examples of such reports include, but are not limited to, accounting reports, security reports, and usage reports. The back end system 112 may also pass data to another server for other functions. Alternatively, the back end system 112 may pass data stored on its database to floor hardware for interaction with a game or game player. For example, data such as a game player's name or the amount of a ticket being redeemed at a game may be passed to the floor hardware. Additionally, the back end system 112 may comprise one or more data repositories for storing data. Examples of types of data stored in the system server data repositories include, but are not limited to, information relating to individual player play data, individual game accounting data, gaming machine accounting data, cashable ticket data, and sound data including optimum audio outputs for various casino settings.

Of course, one will appreciate that a gaming system 100 may also comprise other types of components, and the above illustrations are meant only as examples and not as limitations to the types of components or games used in a casino gaming system capable of presenting a responsible gaming message.

The main cabinet 14 of the gaming machine houses a game monitoring unit (not shown) that includes a CPU, circuitry, and software for receiving signals from the player-activated buttons 13 and/or a handle 15, operating the games, and transmitting signals to the respective game display 17 and speakers 19. The game monitoring unit is a device that is connected to the circuitry of the gaming machine that monitors the game, coin status, player winnings, and other functions of the gaming machine. The game monitoring unit also sends the monitored information to a backend server for processing.

In various embodiments, the game program may be stored in a memory (not shown) comprising a read only memory (ROM), volatile or non-volatile random access memory (RAM), a hard drive or flash memory device or any of several alternative types of single or multiple memory devices or structures.

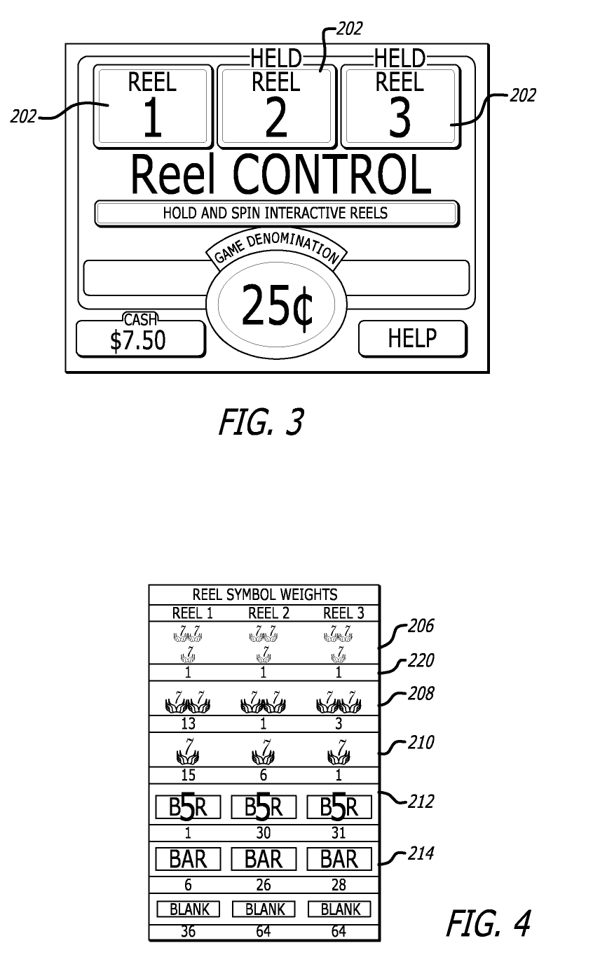

In one particular approach, the present disclosure is incorporated into a Blazing Sevens Reel Control developed for a S9000C cabinet as a 3 reel 5 line game (See FIGS. 3-8). To start a game, a player chooses a number of lines to bet and initiates a game by spinning the reels 200. At this point, the player has an option to hold none to all of the reels 200 (See FIGS. 7 and 8) by touching a corresponding reel graphic or pressing the corresponding hold button 202 (See FIG. 3). The reels 200 not held are then spun again by pressing the spin button (not shown). The result is then evaluated for any winning combinations.

As previously noted, a game incorporating the present disclosure must satisfy pre-established payout percentage regulations such that when X number of credits are bet, it is required that a percentage payback of any bet involving greater than X credits must be greater than or equal to the payback associated with bet X. It is also necessary that all awards for the game be less than 17 million to 1.

With reference to FIG. 4, a game winning percentage is based upon optimal game play. The same is determined by the symbol weights for each reel such as those shown in FIG. 4. Thus, each possible combination has an associated optimal hold strategy that will yield a highest expected value. The symbols 206, 208, 210, 212, 214 and their corresponding weights 220 are displayed to the player.

Accordingly, each weight 220 indicates the odds of the corresponding symbol 206, 208, 210, 212, 214 appearing on a pay line 230 (See FIGS. 7 and 8) with respect to other symbols on the same reel 200. The odds of a symbol 206, 208, 210 appearing on a first pay line 230 are the same as the odds of the symbol appearing above and below the first pay line.

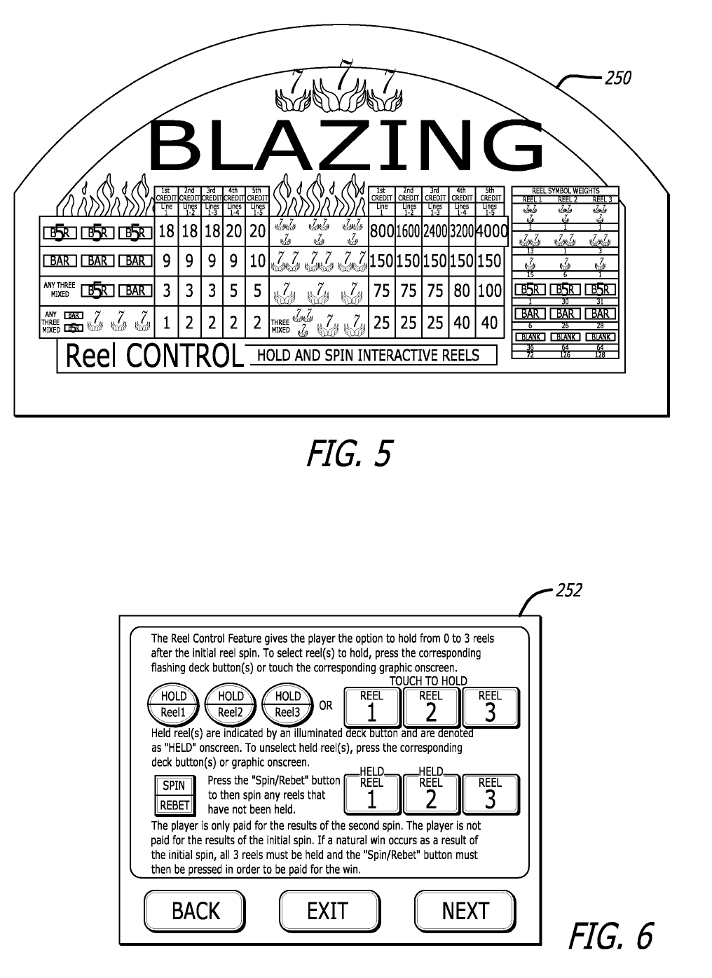

As shown in FIG. 5, the use of full feature glass 250 on a gaming cabinet allows for the creation of generic screen graphics in order to use the same game flash with multiple themed art. This has been evident in the case of the S9000C Classic titles which use the existing S6000 game titles and art. All of the game specific pays and symbols are displayed on the feature glass 250 along with the symbols and weights.

It is further contemplated that a help screen 252 be provided to aid the player. In this regard, as shown in FIG. 6, one game flash can be created with non-theme specific content to be displayed on the screen. Thus, help screens describe the game play and how to hold the reels.

In one specific approach, S9000C Classic titles using S6000 EPROMs can all use one common game flash ASGS9000C000. Because the physical reels are used for game history, graphic symbols can be omitted from the Game History portion of the software. However, since the contemplated games have a hold feature, the video simulator can be relied upon to display the first and second spin as well as the held reels.

Referring specifically now to FIGS. 7 and 8, non-theme specific symbols are used to represent themed symbols indicated on the feature glass and the reel strips. In this case the following associations are used:

A1—Triple Blazing Sevens B1—Bar 5

A2—Double Blazing Sevens B2—Bar

A3—Single Blazing Sevens

In the example shown in FIG. 7, a final result of one game is depicted. Pressing the “Next” button 260 will reveal the initial spin of the same game. HELD graphics can be displayed after pressing the “Show Held” button 262 (See FIG. 8).

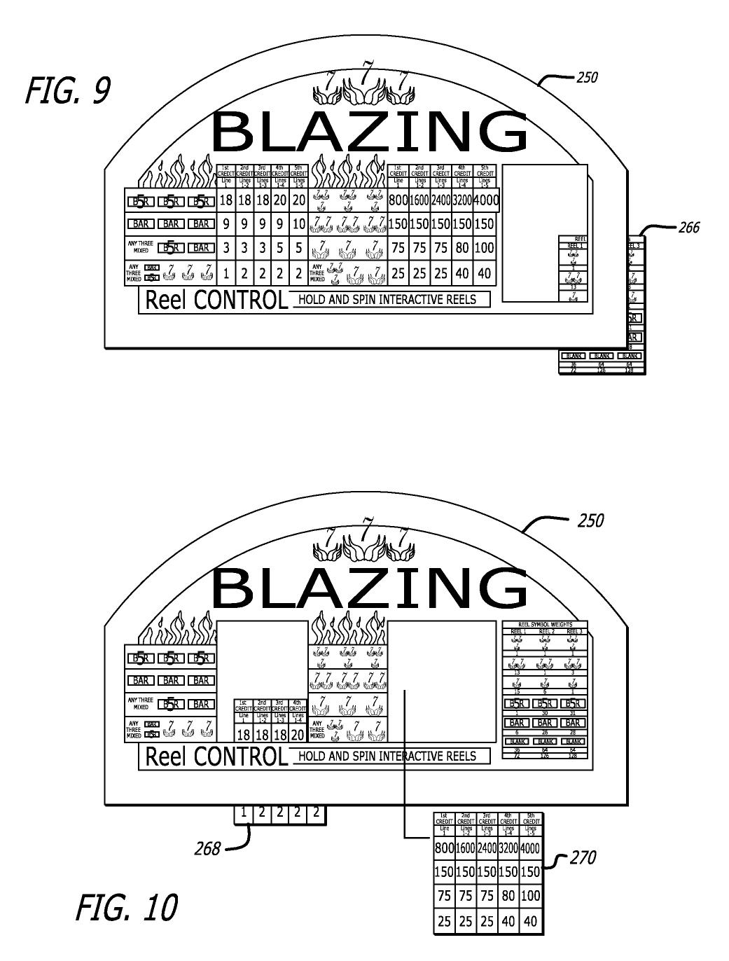

The game percentages are determined by either the symbol weights on each reel or the pays of each winning combination. Different paytables will determine the values displayed on the glass, the same bringing the gaming systems within relevant gaming regulations. As shown in FIGS. 9 and 10, inserts 266, 268, 270 specific to a paytable will be used to display the symbol weights on the feature glass. The inserts for each paytable is thus provided to the player and must be installed in concordance with the configured paytable. Only one paytable can be configured, and a tilt will be generated when the game is configured for multiple paytables.

Accordingly, the present disclosure provides a gaming system and method permitting skill play while incorporating payout percentage schedules which satisfy gaming regulations. In one approach, a multi-line, multi-reel hold and play scheme is contemplated. Thus, a game incorporating the present disclosure facilitates maintaining player excitement between individual games.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A gaming system, comprising:
a gaming device including a plurality of indicia-bearing members;
an activation system operatively associated with the plurality of indicia-bearing members;
a plurality of pay lines involving the indicia-bearing members;
a mechanism that holds a subset of the plurality of pay lines, the subset of plurality of pay lines including a subset plurality of indicia-bearing members; and
a plurality of weighted reel strips, the plurality of weighted reel strips configured to provide a modified payout percentage accommodating varying payouts associated with skill play.

2. The system of claim 1, wherein the plurality of weighted reel strips are virtual weighted reel strips.

3. The system of claim 1, wherein the plurality of weighted reel strips are used for all bets.

4. The system of claim 3, wherein each pay line of the plurality of pay lines has an equal number of hits.

5. The system of claim 1, wherein the indicia-bearing members are symbols.

6. The system of claim 5, wherein a chance of a symbol appearing on a first pay line of the plurality of pay lines is equal to that of the symbol appearing on a second pay line above or below the first pay line.

7. The system of claim 1, wherein a percentage payback of a first bet involving greater than a first number of credits is greater than or equal to a payback associated with the first bet.

8. The system of claim 7, wherein all awards for a game are less than seventeen million to one.

9. The system of claim 1, wherein a game winning percentage is based upon optimal game play.

10. The system of claim 9, wherein optimal game play is determined by symbol weights for each reel of the plurality of wheels.

11. The system of claim 10, wherein the gaming device is configured within a generic screen graphic.

12. The system of claim 11, wherein the gaming device is configured to use a same game flash with multiple themed art.
